(19) United States
(12) Patent Application Publication
(10) Pub. No.: US 2026/0035084 A1
(43) Pub. Date: Feb. 5, 2026

(54) ENERGY STORAGE SYSTEM MANAGEMENT AND FLIGHT PLANNING FOR ELECTRIC AIRCRAFT

(71) Applicant: BETA AIR LLC, South Burlington, VT (US)

(72) Inventors: Steven J. Foland, Garland, TX (US); Stuart Denson Schreiber, Essex, VT (US); Natalie Aulicino, South Burlington, VT (US)

(21) Appl. No.: 19/284,920

(22) Filed: Jul. 30, 2025

Related U.S. Application Data
(60) Provisional application No. 63/678,748, filed on Aug. 2, 2024.

(51) Int. Cl. B64D 31/16; G08G 5/34

(52) U.S. Cl. CPC B64D 31/16; G08G 5/34

(57) ABSTRACT

An energy storage management system and a flight planning system and related methods and program products for an electric aircraft are provided. Systems include a computing device configured to: calculate a performance capability envelope of an energy storage system for an electric aircraft based on a mission profile for a future usage period of the energy storage system and a computational model of the energy storage system. The mission profile includes at least one of an expected energy demand and an expected power demand during at least a portion of a flight of the electric aircraft. The computing device implements a corrective action, such as conducting a performance recovery routine, in response to a comparison of the mission profile to the calculated performance capability envelope indicating a performance deficiency where the energy storage system cannot meet the mission profile within a preset tolerance. The computational model considers memory effect degradation.

### TECHNICAL FIELD

The disclosure relates generally to energy storage. More specifically, the disclosure relates to systems, method and program products for energy storage system management or flight planning system for an electric aircraft.

### BACKGROUND

Electric vehicles and, more particularly, electric aircraft are powered by energy storage systems, e.g., batteries. Assessment of energy storage system health is important to ensure operational safety of the electric vehicles, especially electric aircraft. A variety of transient effects impact the health of energy storage systems. For example, memory effect degradation can impact battery health. Memory effect degradation is a gradual reduction in the charge capability of a rechargeable battery due to repeated recharging after only partial discharge, i.e., the battery seems to “remember” the smaller capacity from the previous recharging. The transient effects are more pronounced in some battery chemistries, such as those with cells having silicon oxide or lithium metal anodes. These transient effects are especially problematic for electric aircraft that operate with a contracted energy envelope due to reserve energy requirements.

One approach to improve energy storage system health is to perform a performance recovery routine to regain energy storage capability lost. In a performance recovery routine, the energy storage system is fully discharged, i.e., to zero or near zero Volts. The full discharge removes dendrites from an anode that limit ion attachment during recharging and thus reduce energy storage capabilities. The performance recovery routine then re-charges the energy storage system to re-establish an arrayed formation of ions on the anode and re-gain the corresponding (lost) energy storage capability. Current recovery approaches employ performance recovery routines after a set number of partial discharge and re-charge cycles.

Without proper planning and preconditioning of energy storage systems, memory effect degradation can lead to incomplete missions and/or emergency situations

### BRIEF DESCRIPTION

All aspects, examples and features mentioned below can be combined in any technically possible way.

An aspect of the disclosure provides a system, comprising: a computing device configured to: calculate a performance capability envelope of an energy storage system for an electric aircraft based on a mission profile for a future usage period of the energy storage system and a computational model of the energy storage system, wherein the mission profile includes at least one of an expected energy demand and an expected power demand during at least a portion of a flight of the electric aircraft; and implement a corrective action in response to a comparison of the mission profile to the calculated performance capability envelope indicating a performance deficiency where the energy storage system cannot meet the mission profile within a preset tolerance.

Another aspect of the disclosure includes any of the preceding aspects, and the computational model includes a usage history of the energy storage system, and calculating the performance capability envelope includes reducing a performance capability according to a memory effect degradation that accounts for the usage history of the energy storage system.

Another aspect of the disclosure includes any of the preceding aspects, and the corrective action includes performing a performance recovery routine to increase an energy storage capability of the energy storage system.

Another aspect of the disclosure includes any of the preceding aspects, and the computational model of the energy storage system for the electric aircraft includes at least one of the following characteristics of the energy storage system: an historical performance of the energy storage system, a charging history of the energy storage system, and empirical performance data based on a chemistry of the energy storage system.

Another aspect of the disclosure includes any of the preceding aspects, and the computational model of the energy storage system includes a model type of the energy storage system.

Another aspect of the disclosure includes any of the preceding aspects, and calculating the performance capability envelope of the energy storage system for the electric aircraft is also based on a voltage, a current and a temperature of the energy storage system.

Another aspect of the disclosure includes any of the preceding aspects, and implementing the corrective action includes performing a performance recovery routine to increase an energy storage capability of the energy storage system to a maximum, fully charged capacity.

Another aspect of the disclosure includes any of the preceding aspects, and the performance recovery routine includes fully discharging the energy storage system from a partially discharged state and then recharging the energy storage system to the maximum, fully charged capacity.

Another aspect of the disclosure includes any of the preceding aspects, and, where performing the performance recovery routine on the energy storage system is temporarily not possible, the computing device is further configured to adjust the mission profile by at least one of the following until the performance recovery routine is performed: changing a flight path of the electric aircraft, reducing a duration of the flight, reducing a power demand of the flight, and converting a phase of a flight from a thrust-borne phase to a wing-borne phase.

Another aspect of the disclosure includes any of the preceding aspects, and implementing the corrective action includes modifying a flight plan of the electric aircraft.

Another aspect of the disclosure includes any of the preceding aspects, and modifying the flight plan includes at least one of: changing a flight path of the electric aircraft, reducing a duration of the flight, reducing a power demand of the flight, and converting a phase of a flight from a thrust-borne phase to a wing-borne phase.

Another aspect of the disclosure includes any of the preceding aspects, and the performance deficiency includes the expected energy demand exceeding a respective energy capability of the energy storage system beyond the preset tolerance therefor.

Another aspect of the disclosure includes any of the preceding aspects, and the performance deficiency includes the expected power demand exceeding a respective power capability of the energy storage system beyond the preset tolerance therefor.

Another aspect of the disclosure includes any of the preceding aspects, and the mission profile further includes an expected energy reserve after completion of the flight, and the performance deficiency includes the expected energy reserve of the mission profile being below the preset tolerance therefor.

Another aspect of the disclosure includes any of the preceding aspects, and the energy storage system includes at least one battery module and a plurality of sensors configured to measure at least one of voltage, current and temperature, wherein the plurality of sensors are operatively coupled to the computing device and calculating the performance capability envelope of the energy storage system for the electric aircraft is also based on the at least one of voltage, current and temperature.

Another aspect of the disclosure includes any of the preceding aspects, and the at least one battery module includes a plurality of battery cells with two or more groups of battery cells connected in parallel and two or more groups of battery cells connected in series.

Another aspect of the disclosure includes a method, comprising: calculating a performance capability envelope of an energy storage system for an electric aircraft based on a mission profile for a future usage period of the energy storage system and a computational model of the energy storage system, wherein the mission profile includes at least one of an expected energy demand and an expected power demand during at least a portion of a flight of the electric aircraft; and implementing a corrective action in response to a comparison of the mission profile to the calculated performance capability envelope indicating a performance deficiency where the energy storage system cannot meet the mission profile within a preset tolerance.

Another aspect of the disclosure includes any of the preceding aspects, and the computational model includes a usage history of the energy storage system, and calculating the performance capability envelope includes reducing a performance capability according to a memory effect degradation that accounts for the usage history of the energy storage system.

Another aspect of the disclosure includes any of the preceding aspects, and the corrective action includes performing a performance recovery routine to increase an energy storage capability of the energy storage system.

Another aspect of the disclosure includes any of the preceding aspects, and the computational model of the energy storage system for the electric aircraft includes at least one of the following characteristics of the energy storage system: an historical performance of the energy storage system, a charging history of the energy storage system, and empirical performance data based on a chemistry of the energy storage system.

Another aspect of the disclosure includes any of the preceding aspects, and the computational model of the energy storage system includes a model type of the energy storage system.

Another aspect of the disclosure includes any of the preceding aspects, and calculating the performance capability envelope of the energy storage system for the electric aircraft is also based on a voltage, a current and a temperature of the energy storage system.

Another aspect of the disclosure includes any of the preceding aspects, and implementing the corrective action includes performing a performance recovery routine to increase an energy storage capability of the energy storage system to a maximum, fully charged capacity.

Another aspect of the disclosure includes any of the preceding aspects, and the performance recovery routine includes fully discharging the energy storage system from a partially discharged state and then recharging the energy storage system to the maximum, fully charged capacity.

Another aspect of the disclosure includes any of the preceding aspects, and where performing the performance recovery routine on the energy storage system is temporarily not possible, further including adjusting the mission profile by at least one of the following until the performance recovery routine is performed: changing a flight path of the electric aircraft, reducing a duration of the flight, reducing a power demand of the flight, and converting a phase of a flight from a thrust-borne phase to a wing-borne phase.

Another aspect of the disclosure includes any of the preceding aspects, and implementing the corrective action includes modifying a flight plan of the electric aircraft

Another aspect of the disclosure includes any of the preceding aspects, and modifying the flight plan includes at least one of: changing a flight path of the electric aircraft, reducing a duration of the flight, reducing a power demand of the flight, and converting a phase of a flight from a thrust-borne phase to a wing-borne phase.

Another aspect of the disclosure includes any of the preceding aspects, and the performance deficiency includes the expected energy demand exceeding a respective energy capability of the energy storage system beyond the preset tolerance therefor.

Another aspect of the disclosure includes any of the preceding aspects, and the performance deficiency includes the expected power demand exceeding a respective power capability of the energy storage system beyond the preset tolerance therefor.

Another aspect of the disclosure includes any of the preceding aspects, and the mission profile further includes an expected energy reserve after completion of the flight, and the performance deficiency includes the expected energy reserve of the mission profile being below the preset tolerance therefor.

Another aspect of the disclosure includes a flight planning system for a flight of an electric aircraft, comprising: a computing device configured to: receive a usage history from an energy storage system of the electric aircraft including a number of cycles of partial discharging and recharging of the energy storage system; calculate a performance capability envelope of an energy storage system for the electric aircraft based on a mission profile for the flight of the energy storage system and a computational model of the energy storage system that includes the usage history, the calculating reducing a performance capability according to a memory effect degradation that accounts for the usage history of the energy storage system; and in response to determining the energy storage system exceeds the performance capability envelope during the flight outside of a preset tolerance, performing a corrective action so the energy storage system does not exceed the performance capability envelope.

Another aspect of the disclosure includes any of the preceding aspects, and the corrective action includes performing a performance recovery routine to increase an energy storage capability of the energy storage system.

Another aspect of the disclosure includes any of the preceding aspects, and the performance recovery routine includes fully discharging the energy storage system from a partially discharged state and then recharging the energy storage system to a maximum, fully charged capacity.

Another aspect of the disclosure includes any of the preceding aspects, and the corrective action includes modifying a flight plan of the electric aircraft

Another aspect of the disclosure includes any of the preceding aspects, and modifying the flight plan includes at least one of: changing a flight path of the electric aircraft, reducing a duration of the flight, reducing a power demand of the flight, and converting a phase of a flight from a thrust-borne phase to a wing-borne phase.

Another aspect of the disclosure includes any of the preceding aspects, and calculating the performance capability envelope of the energy storage system for the electric aircraft is also based on: a flight duration, anticipated non-temperature weather conditions, anticipated weather temperature, a flight distance, a flight intended path, an electric aircraft load and an age of the energy storage system.

A computer program product stored on a computer readable storage medium, which when executed by a computing device, performs a method for managing an energy storage system, the method comprising: calculating a performance capability envelope of an energy storage system for an electric aircraft based on a mission profile for a future usage period of the energy storage system and a computational model of the energy storage system, wherein the mission profile includes at least one of an expected energy demand and an expected power demand during at least a portion of a flight of the electric aircraft; and implementing a corrective action in response to a comparison of the mission profile to the calculated performance capability envelope indicating a performance deficiency where the energy storage system cannot meet the mission profile within a preset tolerance.

Two or more aspects described in this disclosure, including those described in this summary section, may be combined to form implementations not specifically described herein. That is, all embodiments described herein can be combined with each other.

The details of one or more implementations are set forth in the accompanying drawings and the description below. Other features, objects and advantages will be apparent from the description and drawings, and from the claims.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows a perspective view of an illustrative electric aircraft environment for a system, method and program product, according to embodiments of the disclosure;

FIG. 2 shows a schematic block diagram of an energy storage system, according to embodiments of the disclosure;

FIG. 3 shows a block diagram of systems, according to embodiments of the disclosure;

FIG. 4 shows a flow diagram of an operational methodology for the systems, according to embodiments of the disclosure;

FIGS. 5A and 5B shows graphical representations of mission profiles, according to embodiments of the disclosure;

FIG. 6 shows a graphical representation of partial discharge and recharging of an electric storage system and a related memory effect degradation;

FIGS. 7A and 7B show graphical representations of a performance capability envelope versus a mission profile based on power demand, according to embodiments of the disclosure;

FIGS. 8A and 8B show graphical representations of a performance capability envelope versus a mission profile based on energy demand, according to embodiments of the disclosure; and

FIG. 9 shows a graphical representation of partial discharge and recharging of an electric storage system with a related memory effect degradation and a performance recovery routine, according to embodiments of the disclosure.

It is noted that the drawings of the disclosure are not necessarily to scale. The drawings are intended to depict only typical aspects of the disclosure and therefore should not be considered as limiting the scope of the disclosure. In the drawings, like numbering represents like elements between the drawings.

### DETAILED DESCRIPTION

As an initial matter, in order to clearly describe the subject matter of the current technology, it will become necessary to select certain terminology when referring to and describing relevant components within the illustrative application of a energy storage management system or a flight planning system for an electric aircraft. When doing this, if possible, common industry terminology will be used and employed in a manner consistent with its accepted meaning. Unless otherwise stated, such terminology should be given a broad interpretation consistent with the context of the present application and the scope of the appended claims. Those of ordinary skill in the art will appreciate that often a particular component may be referred to using several different or overlapping terms. What may be described herein as being a single part may include and be referenced in another context as consisting of multiple components. Alternatively, what may be described herein as including multiple components may be referred to elsewhere as a single part.

Several descriptive terms may be used regularly herein, as described below. The terms “first,” “second,” and “third,” may be used interchangeably to distinguish one component from another and are not intended to signify location or importance of the individual components. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event may or may not occur or that the subsequently described feature may or may not be present and that the description includes instances where the event occurs or the feature is present and instances where the event does not occur or the feature is not present.

Where an element or layer is referred to as being “on,” “engaged to,” “connected to,” “coupled to,” or “mounted to” another element or layer, it may be directly on, engaged, connected, coupled, or mounted to the other element or layer, or intervening elements or layers may be present. In contrast, when an element is referred to as being “directly on,” “directly engaged to,” “directly connected to,” or “directly coupled to” another element or layer, there are no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items. The verb forms of “couple” and “mount” may be used interchangeably herein.

Embodiments of the disclosure include an energy storage management system and a flight planning system for an electric aircraft. The systems include a computing device configured to: calculate a performance capability envelope of an energy storage system for an electric aircraft based on a mission profile for a future usage period of the energy storage system and a computational model of the energy storage system. The mission profile may include at least one of an expected energy demand and an expected power demand during at least a portion of a flight of the electric aircraft. The computing device also implements a corrective action, such as conducting a performance recovery routine, in response to a comparison of the mission profile to the calculated performance capability envelope indicating a performance deficiency where the energy storage system cannot meet the mission profile within a preset tolerance. The computational model may consider memory effect degradation, which is a gradual reduction in the charge capability of a rechargeable battery due to repeated recharging after only partial discharge, i.e., the battery seems to ‘remember’ the smaller capacity from the previous recharging. The memory effect degradation may impact total energy, performance capability or a combination of both. In contrast to conventional approaches that perform a performance recovery routine after a set number of partial discharge and re-charge cycles, embodiments of the disclosure perform the performance recovery routine based on a performance deficiency indicated by the performance capability envelope that considers memory effect degradation and the mission profile. Hence, the performance recovery routine can be more accurately used to ensure the electric aircraft can complete the mission and/or avoid emergency situations. Other corrective actions are also possible. Embodiments of the disclosure also include related methods and program products.

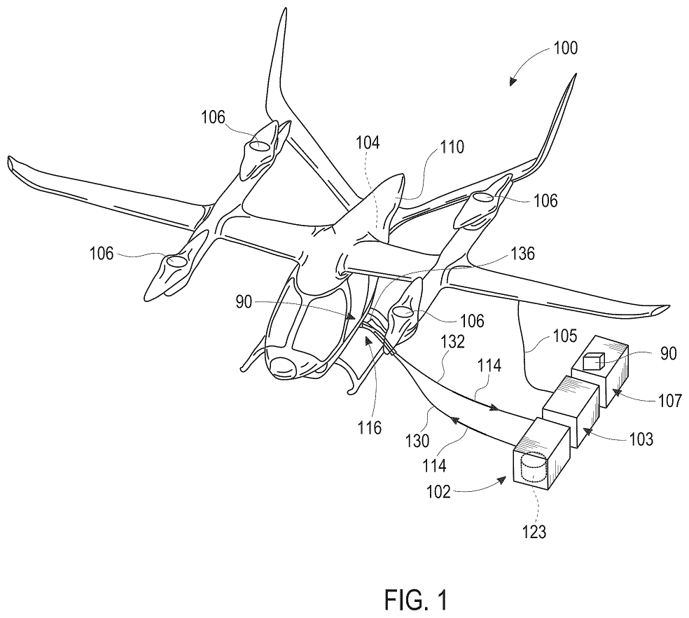

FIG. 1 shows a perspective view of an illustrative environment in which an energy storage management system or flight planning system 90 (hereafter “system 90”) according to embodiments of the disclosure is used on an electric aircraft. Electric vehicle 100 will be described herein as an electric aircraft, but it could alternatively be an electric automobile, marine vehicle, drone, etc. While embodiments of the disclosure will be described relative to electric aircraft environment, it will be understood that system 90 may be applicable in a wide variety of other environments in which energy storage health management in the face of transient effects, such as memory effect degradation, is desired. As will be described, methods, program producs and systems for flight planning and/or energy storage system management, e.g., performance capability analysis and correction, for electric vehicle 100 are provided herein.

A brief introduction of electric vehicle 100 in the form of an electric aircraft (hereafter “electric aircraft 100”) and parts of a ground-based systems therefor will now be provided. Further details of electric aircraft 100 are provided herein. Electric aircraft 100 may include any battery-powered aircraft that can fly such as airplanes, helicopters, airships, blimps, gliders, paramotors, or similar vehicles. More particularly, electric aircraft 100 may include any now known or later developed vehicle that includes one or more propulsors 106 and an energy storage system (ESS) 104, such as a battery or battery pack, configured to power propulsor(s) 106. Electric aircraft 100 also has a fuselage 110 that encloses, among other things, ESS 104. As will be described herein, propulsor(s) 106 may be one of a number of actuators on electric aircraft 100. As shown in FIG. 1, electric aircraft 100 may also operatively couple to a charging system 103 through a separate charging and/or electrical communication cable 105. A central control system 107 may alone, or in conjunction with control systems on electric aircraft 100, control and/or coordinate operation of system 90, a thermal conditioning system 102 and/or a charging system 103.

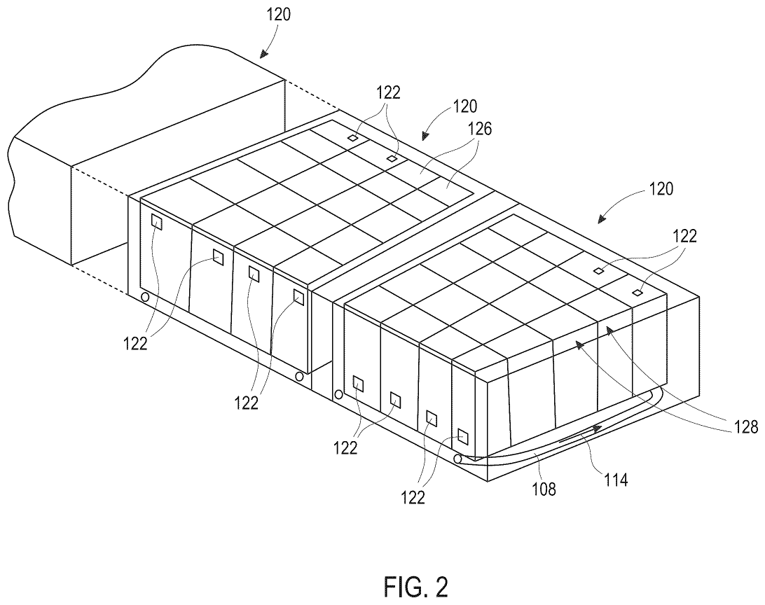

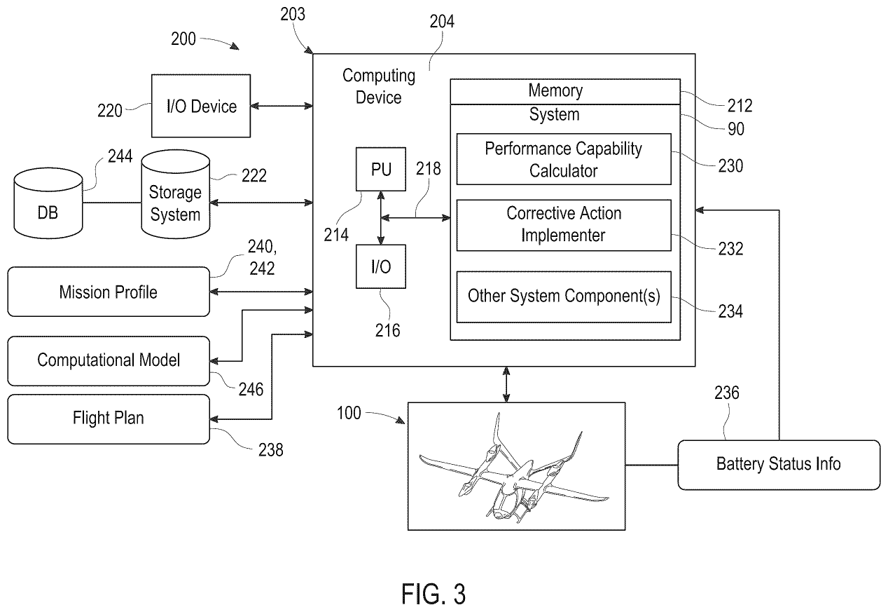

FIG. 2 shows a schematic view of an illustrative ESS 104. For purposes of description, ESS 104 includes at least one battery module 120 and a plurality of sensors 122 configured to measure at least one of voltage, current and temperature and, perhaps, other characteristics of ESS 104. Sensors 122 are operatively coupled to computing device 204 (FIG. 3) of system 90 for calculating a performance capability envelope of ESS 104 for electric vehicle 100, which may be based on the at least one of voltage, current and temperature measured by sensors 122. ESS 104 can take any variety of well-known battery arrangements. In one example, battery module(s) 120 includes a plurality of battery cells 124 with two or more groups of battery cells 126 connected in parallel and two or more groups of battery cells 128 connected in series. Other arrangements of battery cells and/or modules are also possible. As recognized in the field, a liquid-based thermal conditioning circuit 108 may control a thermal condition, e.g., overall temperature or other thermal attribute, of ESS 104. Liquid-based thermal conditioning circuit 108 (hereafter “circuit 108” for brevity) may include any now known or later developed circuit to, for example, cool and/or heat ESS 104. In one non-limiting example, circuit 108 may include conduits, such as pipes, to fluidly communicate a thermal conditioning liquid 114 around at least part of ESS 104, and may also include various heat exchangers, manifolds, pumps, valves, orifices, couplings, and/or any related sensors and control systems. Circuit 108 may take any path in and around at least part of ESS 104 but, as shown in FIG. 1, returns to a port location 116 at an exterior of fuselage 110 where it fluidly couples to a ground-based thermal conditioning system 102.

Ground-based thermal conditioning system 102 (hereafter “conditioning system 102”) may include any now known or later developed system to provide thermal conditioning liquid 114 to circuit 108. More particularly, conditioning system 102 may include any now known or later developed hardware and/or software to provide thermal conditioning liquid 114 at a controlled temperature and rate, such as but not limited to: pumps, filters, chillers, heaters, sensors, valves. Liquid 114 may include any now known or later developed liquid capable of the required heat transfer characteristics. In non-limiting examples, liquid 114 may include water, anti-freeze like propylene glycol, thermal oil, etc.

Conditioning system 102 and/or electric charging system 103 may also include any necessary central control systems 107 which may be optionally in electrical communication with sensors 122 and/or control systems in electric aircraft 100. Conditioning system 102 may be coupled to electric aircraft 100 using a pair of conduits 130, 132 that may be coupled to a handle 136 for ease of handling and attaching to electric aircraft 100. Conduits 130, 132 may include any variety of hoses or tubes (e.g., flexible hoses or tubes) for conveying liquid 114 and are typically of sufficient strength to withstand exposure to repeated flexing, ground contact and environmental conditions. Although wireless communications with control systems within electric aircraft 100 are an option, any necessary electrical connections (not shown) may also be routed with conduits 130, 132 and through handle 136 or through charging and/or electrical communication cable 105.

FIG. 3 shows a block diagram of system 90 according to embodiments of the disclosure. As will be appreciated by one skilled in the art, system 90 according to the present disclosure may be embodied as a system, method or computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product embodied in any tangible medium of expression having computer-usable program code embodied in the medium. System 90 described herein may be located on electric aircraft 100 (or other form of electric vehicle, e.g., automobile, etc.); part of charging system 103; part of central control system 107; in a cloud server environment; or a combination any of the above.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, a magnetic storage device, or a solid state storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present disclosure may be written in any combination of one or more programming languages, including an object-oriented programming language such as Javascript, Java, Python, Ruby, C++ or the like and scripting programming languages, such as the Python, Perl or Bash programming languages or similar programming languages. Other programming languages may also be possible. The program code may execute entirely on a user's computer (e.g., computing device 204 (FIG. 3), central control system 107, etc.), partly on the user's computer, as a stand-alone software package, partly on the user's computer and partly on a remote computer (e.g., flight planning system) or entirely on the remote computer or server. In the latter scenario, the remote computer may be connected to the user's computer or electric aircraft 100 through any type of network, including a local area network (LAN) or a wide area network (WAN), or the connection may be made to an external computer (for example, through the Internet using an Internet Service Provider).

The present disclosure is described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

FIG. 3 shows an illustrative environment 202 for system 90. To this extent, environment 202 includes a computer infrastructure 203 that can perform the various process steps described herein for system 90. In particular, computer infrastructure 203 is shown including a computing device 204 that comprises system 90, which enables computing device 204 to provide the functions of system 90 by performing the process steps of the disclosure.

Computing device 204 is shown including a memory 212, a processor (PU) 214, an input/output (I/O) interface 216, and a bus 218. Further, computing device 204 is shown in communication with an external I/O device/resource 220 and a storage system 222. As is known in the art, in general, processor 214 executes computer program code, such as system 90, that is stored in memory 212 and/or storage system 222. While executing computer program code, processor 214 can read and/or write data, such as operational data, to/from memory 212, storage system 222, and/or I/O interface 216. Bus 218 provides a communications link between each of the components in computing device 204. I/O device 216 can comprise any device that enables a user to interact with computing device 204 or any device that enables computing device 204 to communicate with one or more other computing devices. Input/output devices including but not limited to keyboards, displays, pointing devices, etc., can be coupled to the system either directly or through intervening I/O controllers.

In any event, computing device 204 can comprise any general-purpose computing article of manufacture capable of executing computer program code installed by a user (e.g., a personal computer, server, handheld device, etc.). However, it is understood that computing device 204 and system 90 are only representative of various possible equivalent computing devices that may perform the various process steps of the disclosure. To this extent, in other embodiments, computing device 204 can comprise any specific purpose computing article of manufacture comprising hardware and/or computer program code for performing specific functions, any computing article of manufacture that comprises a combination of specific purpose and general-purpose hardware/software, or the like. In each case, the program code and hardware can be created using standard programming and engineering techniques, respectively.

Similarly, computer infrastructure 203 is only illustrative of various types of computer infrastructures for implementing the disclosure. For example, in one embodiment, computer infrastructure 203 comprises two or more computing devices (e.g., a server cluster) that communicate over any type of wired and/or wireless communications link, such as a network, a shared memory, or the like, to perform the various process steps of the disclosure. When the communications link comprises a network, the network can comprise any combination of one or more types of networks (e.g., the Internet, a wide area network, a local area network, a virtual private network, etc.). Network adapters may also be coupled to the system to enable the data processing system to become coupled to other data processing systems or remote printers or storage devices through intervening private or public networks. Modems, cable modem and Ethernet cards are just a few of the currently available types of network adapters. Regardless, communications between the computing devices may utilize any combination of various types of transmission techniques.

As previously mentioned and discussed further below, system 90 enables computing infrastructure 203 to collect data from, e.g., sensors 122 or a user, and transmit operational instructions, e.g., corrective actions such as a modified flight plan, to a user or electric aircraft 100. (System 90 may also access other data regarding electric aircraft 100 and ESS 104 thereof from other sources.) To this extent, system 90 is shown including a performance capability calculator 230 and a corrective action implementer 232 that provide, at least in part, functions of system 90 as will be described herein. System 90 may also include other system components 234 capable of system 90 functions other than as expressly described herein. Other system components 234 may include any now known or later developed ESS 104 and/or electric aircraft 100 components and/or functions for operating electric aircraft 100. It is understood that some of the various sub-systems and functions shown in FIG. 3 can be implemented independently, combined, and/or stored in memory for one or more separate computing devices that are included in computer infrastructure 203. Further, it is understood that some of the sub-systems and/or functionality may not be implemented, or additional systems and/or functionality may be included as part of environment 202.

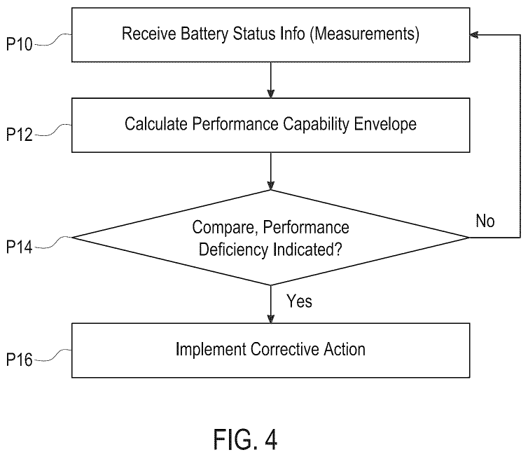

With reference to FIGS. 1-4, a computer-implemented method for flight planning and ESS 104 management, e.g., performance capability analysis and correction, for electric aircraft 100 will now be described. FIG. 4 shows a flow diagram for describing the computer-implemented methods according to embodiments of the disclosure.

In process P10, system 90 may optionally receive data, such as battery status information 236 (FIG. 3) from ESS 104 of electric aircraft 100 or a flight plan 238 from a user or another flight planning system (not shown). Battery status information 236 may include one or more measurable characteristics of ESS 104, e.g., measurable by sensors 122 (FIG. 2). Battery status information 236 may include but is not limited to one or more of present voltage, current and temperature of ESS 104. Battery status information 236 may be of ESS 104 overall or individual modules 120, individual cells and/or groups of cells 126, 128. As will be understood, sensor(s) 122 can be positioned in a wide range of locations within ESS 104 to obtain battery status information 236 at any desired level of granularity. Although battery status information 236 is shown as coming from electric aircraft 100, it may be stored elsewhere for access by system 90. Flight plan 238 may take any now known or later developed form providing, for example, a flight path, stops, anticipated weather, etc., and may be user or computer generated. For example, flight plan 238 may be generated using any now known or later developed flight planning systems, which may be part of or separate from system 90. As the operation of such flight planning systems are well known to those will skill in the art, no further detail is provided so the reader can focus on the salient points of the disclosure.

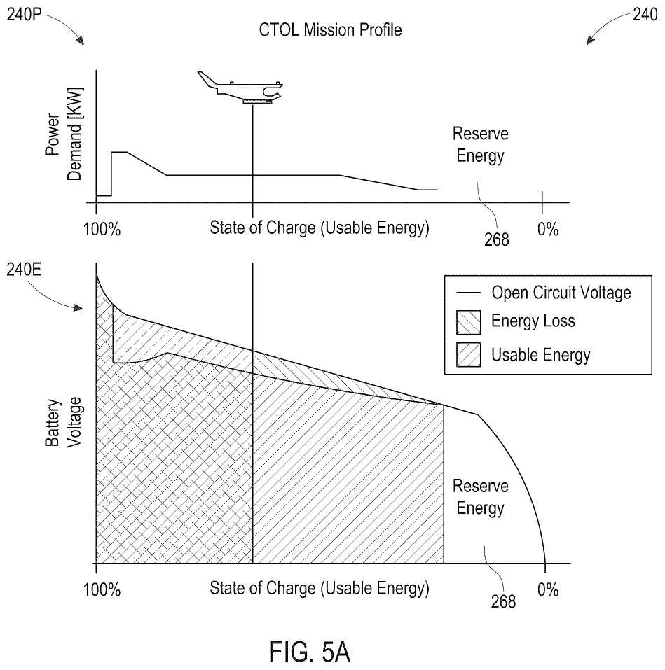

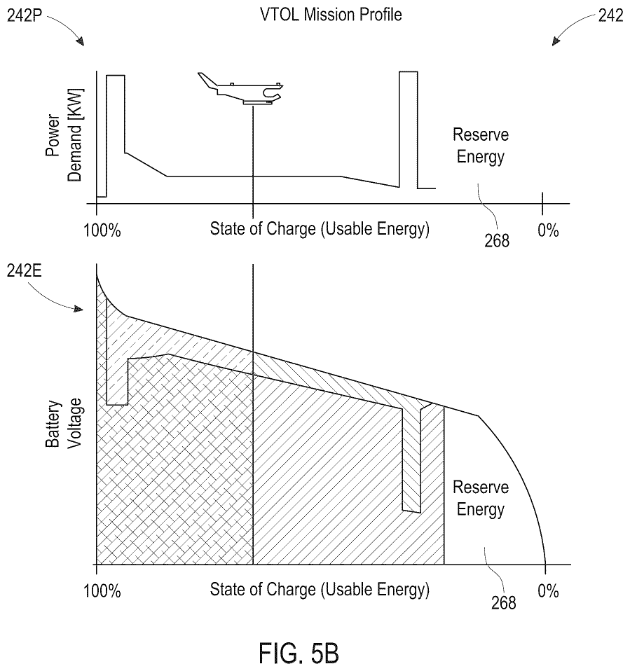

In process P12, system 90 calculates a performance capability envelope of ESS 104 for electric aircraft 100 based on a mission profile 240, 242 (FIGS. 3, 5A-B) for a future usage period of ESS 104 and a computational model 246 (FIG. 3) of ESS 104 (FIGS. 1, 5A-B). The performance capability envelope generally describes how ESS 104 will operate under load. Mission profile 240, 242 may be generated using any now known or later developed mission profile generating systems, which may be part of or separate from system 90. As the operation of such mission profile systems are well known to those will skill in the art, no further detail is provided so the reader can focus on the salient points of the disclosure. It will be recognized that mission profiles 240, 242 are based on a wide variety of information about a mission or flight of electric aircraft 100 such as but not limited to: a flight duration, anticipated non-temperature weather conditions, anticipated weather temperature, a flight distance, a flight intended path, and an electric aircraft load.

FIGS. 5A-B show variations of a mission profile for ESS 104 for two types of electric aircraft 100. More particularly, FIG. 5 shows a mission profile 240 for a conventional takeoff and landing (CTOL) aircraft, and FIG. 5B shows a mission profile 242 for a vertical takeoff and landing (VTOL) aircraft. CTOL aircraft are mainly capable of wing-borne flight, e.g., via a rush of air over a wing. In contrast, VTOL aircraft are capable of thrust-borne vertical propulsion, e.g., by directing air mainly downwardly using a propellor to cause flight and may also have some conventional wing-borne flight capabilities, e.g., via a rush of air over a wing. As shown in FIGS. 5A-B, a mission profile 240, 242 may include at least one of an expected energy demand (mission profiles 240E, 242E, lower sections of FIGS. 5A-B) and an expected power demand (mission profiles 240P, 242P, upper sections of FIGS. 5A-B) during at least a portion of a flight of electric aircraft 100. Expected power demand and expected energy (i.e., battery voltage) is shown versus state of charge (also known as ‘usable energy’) of ESS 104. FIGS. 5A-B show mission profiles 240, 242 for an entire flight of electric aircraft 100. Hence, the expected energy demand and expected power demand both start at 100% and decrease to 0% over the mission from left-to-right on the page. It is understood by those will skill in the art, however, ESSs 104 for electric aircraft 100 are required by governmental agencies to maintain a reserve energy (see ‘Reserve Energy’ section in each mission profile), and should never reach full discharge, i.e., 0%, during a flight. In the example shown in FIG. 5A, for a CTOL electric aircraft 100, power demand is highest at takeoff with a ramp down just after takeoff and during landing, and otherwise diminishes gradually in a generally linear manner. Energy demand for CTOL electric aircraft 100 shows similar high decreases at takeoff and at landing. In the example shown in FIG. 5B, for a VTOL electric aircraft 100, power demand is highest at takeoff and landing with ramp downs just after takeoff and just prior to landing, and otherwise it diminishes gradually in a generally linear manner. Energy demand for VTOL electric aircraft 100 shows similar high demand (decreases) at takeoff and at landing.

It is emphasized that the mission profiles 240, 242 shown in FIGS. 5A-B for electric aircraft 100 are relatively simple for description purposes and may be complicated by a large number of flight factors such as but not limited to: number of expected takeoff/landings during a complete flight/mission, weather conditions, aircraft load and/or changes therein, aircraft speed and/or aircraft altitude. As understood in the field, mission profiles 240, 242 may be generated in any now known or later developed manner such as but not limited to being based on: ESS 104 prior missions and the afore-mentioned flight factors. Mission profiles 240, 242 may be based on a predicted mission, a predefined mission and/or a nominal mission. The estimations used to estimate the power demand and/or energy demand over the course of the mission profile may be set as conservative as desired.

Computational model 246 of ESS 104 may include any now known or later developed form of digital representation of ESS 104. As noted, the performance capability envelope generally describes how ESS 104 will operate under load. In certain embodiments, computational model 246 may include any now known or later developed modeling format such as but not limited to: an equivalent circuit model (e.g., approximating ESS electrochemistry), a physical model (e.g., describing actual electrochemical reactions at ESS electrodes and diffusion rates thereof), or a non-deterministic machine learning or other artificial intelligence model. Computational model 246 may influence the performance capability envelope by, for example, analyzing power demand and how that demand impacts ESS 104 resulting output voltage and current to meet that power demand. The computational model may also analyze other operational parameters such thermal performance such as heat evolution within ESS 104 and heat dissipation outside of ESS 104. Computational model 246 may include other parameters such as a usage history of ESS 104, which may include but is not limited to: memory effect degradation, how many partial discharge and recharge cycles it has experienced, duration between charges, and age. As noted, memory effect degradation is a gradual reduction in the discharged voltage capability of a rechargeable battery due to repeated recharging after only partial discharge, i.e., the battery seems to “remember” the smaller capacity from the previous recharging. Transient effects, such as memory effect degradation, are more pronounced in some battery chemistries, such as those with cells having silicon oxide or lithium metal anodes (e.g., lithium nickel manganese cobalt (Li-NMC) anodes or lithium nickel cobalt aluminum (Li-NCA) anodes). These transient effects are especially problematic for electric aircraft 100 that operate with a contracted energy envelope due to the aforementioned reserve energy requirements—see FIGS. 5A-B. Regardless of how calculated and what model parameters are used, the performance capability model will describe ESS will operate under load. More specifically, under a situation with a given power demand (load) and a given energy state (e.g., a state of health, state of charge or any other age-defining parameter of ESS), the performance capability model will describe how ESS will operate, e.g., output voltage, current and other parameters.

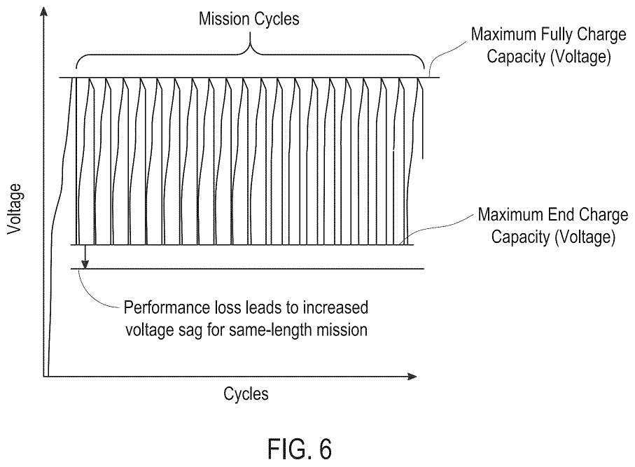

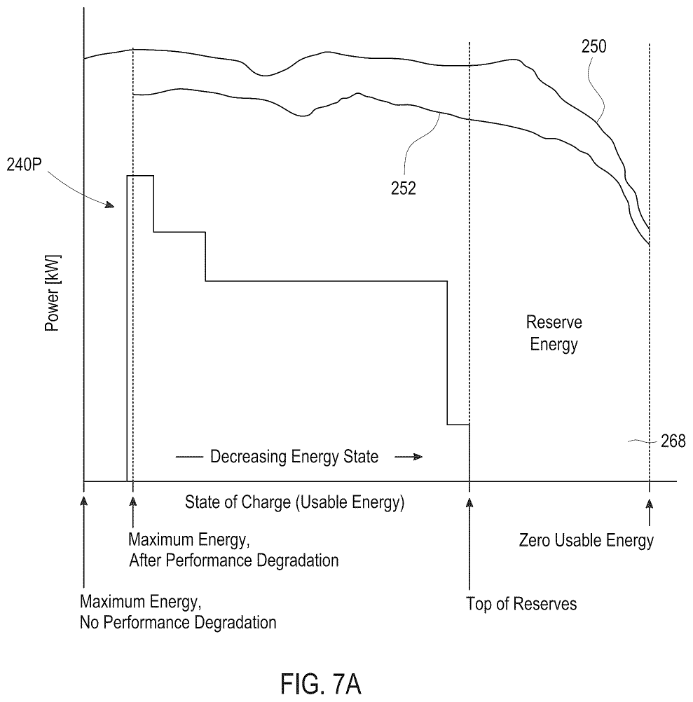

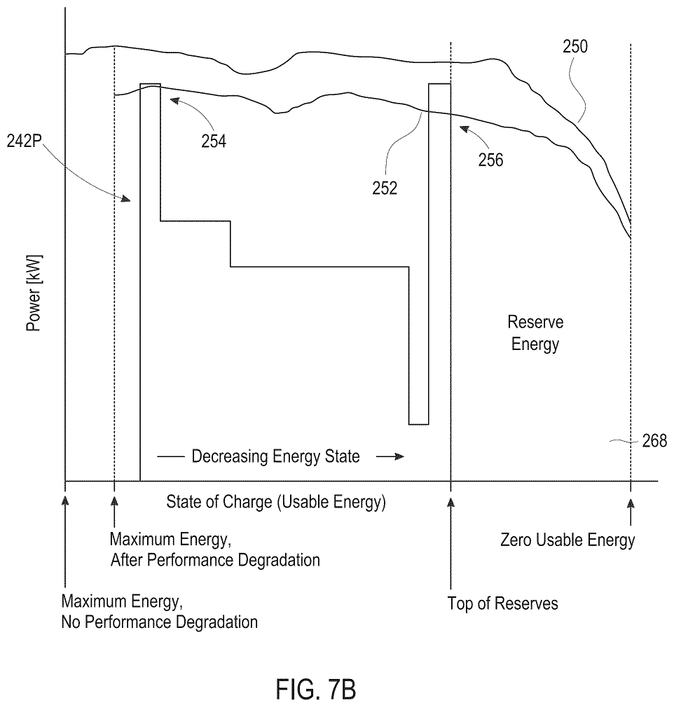

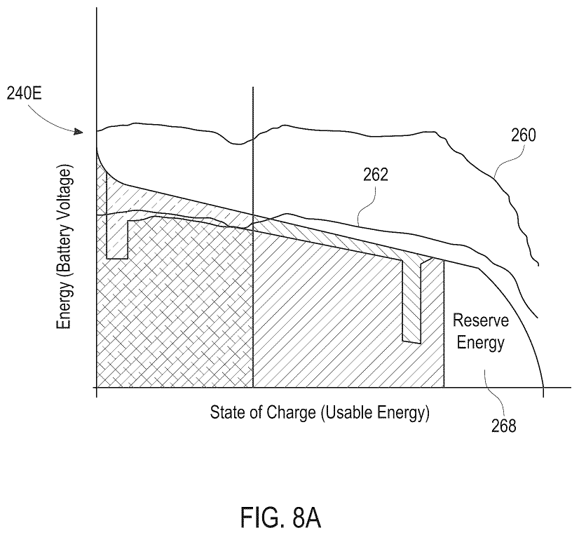

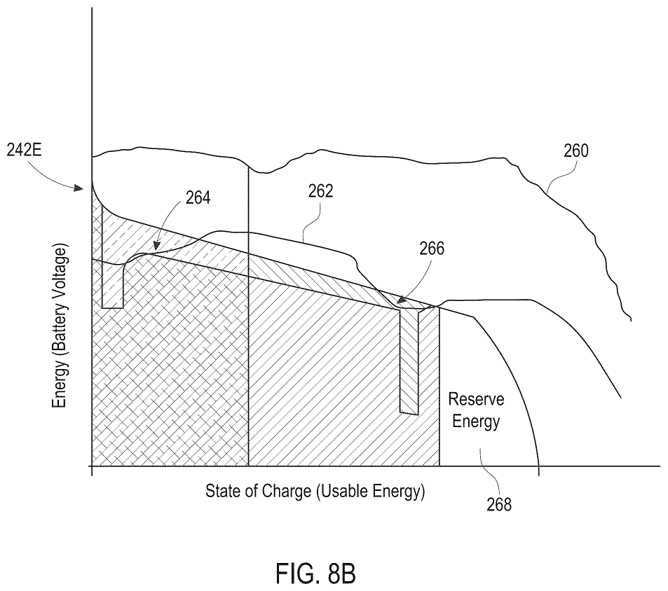

FIG. 6 shows a graphical representation of mission cycles and how partial discharge and then recharge diminishes a charged capacity of ESS 104 from an expected end discharge capacity. As illustrated, each same-length mission cycle results in a decreased end voltage over time and related performance loss. In process P12, system 90 calculates a performance capability envelope that reduces a performance capability according to the memory effect degradation. That is, calculating the performance capability envelope 250, 252 (FIGS. 7A-B) and 260, 262 (FIGS. 8A-B) includes reducing a performance capability according to a memory effect degradation that accounts for the usage history of ESS 104. Hence, an anticipated voltage capacity is reduced compared to the maximum end charge capacity, i.e., the maximum end capacity prior to repeated cycles of partial discharge/re-charge activities.

In other embodiments, computational model 246 of ESS 104 for electric aircraft 100 also includes at least one of the following characteristics of ESS 104: historical performance of ESS 104 (e.g., history of actual performance versus expected performance), a charging history of ESS 104 (e.g., number of discharge-charge cycles and the depth of discharge of each), and empirical performance data based on a chemistry of ESS 104. As noted, different chemistries used in ESS 104 may result in different historical performance, charging history and/or memory effect degradation. For example, ESSs 104 using silicon oxide (SiO₂) anodes or lithium metal anodes function differently than other chemistries. To address this situation, computational model 246 of ESS 104 may include a model type of ESS 104 including, for example, the chemistry used and/or a physical arrangement of ESS 104. In other embodiments, system 90 calculates performance capability envelope 250, 252 of ESS 104 for electric aircraft 100 also based on a present voltage, a current and a temperature of ESS 104. The present voltage, a current and a temperature of ESS 104 may be provided as part of battery status information (info) 236 or as part of computational model 246, as shown in FIG. 3, or otherwise obtained from sensors 122 (FIG. 2) of ESS 104.

System 90 can calculate performance capability envelope of ESS 104 for electric aircraft 100 based on mission profile 240, 242 (FIGS. 3, 5A-B) and computational model 246 (FIG. 3) of ESS 104 (FIGS. 1, 5A-B) in any of a variety of ways. For example,

FIGS. 7A-B show graphical representations of illustrative performance capability envelopes 250, 252 for a CTOL aircraft (FIG. 7A) and a VTOL aircraft (FIG. 7B), respectively, based on power demand. The performance capability envelopes are interposed with illustrative power demand mission profiles 240P, 242P, similar to those shown in FIGS. 5A-B, respectively. In FIGS. 7A-B, an upper line (labeled 250) in the graphs indicates a conventional performance capability envelope, without consideration of memory effect degradation, and a lower line (labeled 252) in the graphs indicates performance capability envelope according to embodiments of the disclosure. Similarly, FIGS. 8A-B show graphical representations of illustrative performance capability envelopes 260, 262 for a CTOL aircraft (FIG. 8A) and a VTOL aircraft (FIG. 8B), respectively, based on energy demand. The performance capability envelopes are interposed with illustrative energy demand mission profiles 240E, 242E similar to those shown in FIGS. 5A-B, respectively. In FIGS. 8A-B, an upper line (labeled 260) in the graphs indicates a conventional performance capability envelope, without consideration of memory effect degradation, and a lower line (labeled 262) in the graphs indicates a performance capability envelope according to embodiments of the disclosure. Note, FIGS. 7A-B also show a reduction in ‘maximum energy, no performance degradation’ due to memory effect degradation to ‘maximum energy after performance degradation’ due to memory effect degradation, e.g., from 100% to 90%.

Returning to FIG. 4, in process P14, system 90 compares mission profile 240, 242 to the calculated performance capability envelope 252, 252 or 260, 262 (FIGS. 7A-B, 8A-B). For example, as shown in FIG. 7A, for the illustrative mission profile 240P for a CTOL aircraft, mission profile 240 requirements never exceed performance capability envelopes 250, 252 without consideration of memory effect degradation. In contrast, as shown in FIG. 7B, for the illustrative mission profile 242P for a VTOL electric aircraft, mission profile 242 requirements do not exceed performance capability envelopes 250 without consideration of memory effect degradation, but for performance capability envelope 252 that considers of memory effect degradation, mission profile 242P exceeds the performance capability of ESS 104 in two locations: at takeoff 254 and landing 256. In other examples, as shown in FIG. 8A, for the illustrative mission profile 240E for a CTOL aircraft, mission profile 240E requirements exceed performance capability envelopes 262 with consideration of memory effect degradation, but not performance capability envelopes 260 without consideration of memory effect degradation. Similarly, as shown in FIG. 8B, for the illustrative mission profile 242E for a VTOL electric aircraft, mission profile 242 requirements do not exceed performance capability envelope 260 without consideration of memory effect degradation, but for performance capability envelope 262 that considers memory effect degradation, mission profile 242E exceeds the performance capability of ESS 104 in two locations: at takeoff 264 and landing 266. It will be noted that use of mission profiles for power demand or energy demand may have different results. One or both formats of mission profile may be used.

Where ESS 104 cannot meet mission profile 240, 242 within a preset tolerance, system 90 indicates a performance deficiency. Performance deficiencies can take a variety of forms. For example, the performance deficiency may include the expected power demand, as dictated by mission profile 240P, 242P (FIGS. 7A-B), exceeding a respective power capability of ESS 104 (as dictated by performance capability envelope 252 in FIGS. 7A-B) beyond the preset tolerance therefor. In certain embodiments, system 90 may indicate a performance deficiency where mission profile 240, 242 simply exceeds the performance capability of ESS 104, i.e., no or little preset tolerance. In another example, a preset tolerance may be used, such as 5% of maximum power deman. Here, where mission profile 240P, 242P (FIGS. 7A-B) exceeds a value of 95% of power deman of the performance capability of ESS 104, system 90 may indicate a performance deficiency. As will be recognized, a wide variety of alternative forms of preset tolerances can be used, all of which can be user-defined.

In other embodiments, as shown in FIGS. 5A-B, 7A-B and 8A-B, mission profile 240E, 242E may include an expected energy reserve 268 after completion of a flight. In certain embodiments, system 90 may indicate a performance deficiency where the expected energy reserve of mission profile 240, 242 is below a preset tolerance therefor.

Returning to FIG. 4, where a proficiency deficiency is not indicated, i.e., ‘No” at process P14, system 90 continues processing through steps P10-P14. Where a proficiency deficiency is indicated, i.e., ‘Yes” at process P14, system 90 continues to process P16, where it implements a corrective action. That is, system 90 implements corrective action in response to a comparison of mission profile 240, 242 to the calculated performance capability envelope 250, 252 indicating a performance deficiency where ESS 104 cannot meet mission profile 240, 242 within a preset tolerance.

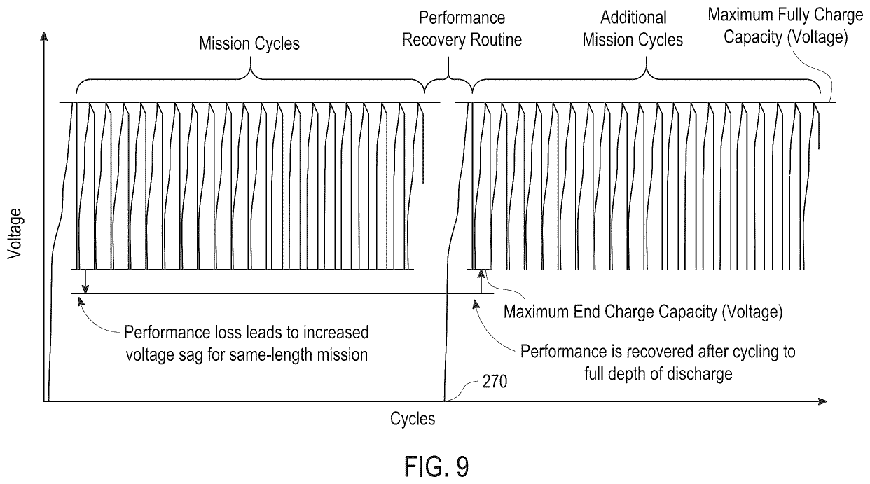

The corrective action taken by system 90 can take a variety of forms. In certain embodiments, system 90 may implement a corrective action by performing a performance recovery routine to increase an energy storage capability of ESS 104. FIG. 9 shows a graphical representation of mission cycles similar to FIG. 6, but with a performance recovery routine implemented. More particularly, FIG. 9 shows how partial discharge and then recharge diminishes a maximum end charged capacity of ESS 104 from a maximum end charge capacity as in FIG. 6, but also shows system 90 performing a performance recovery routine to increase an energy storage capability of ESS 104 to a maximum end charge capacity. In certain embodiments, the performance recovery routine may include fully discharging ESS 104 (see point 270 in FIG. 9) from a partially discharged state and then recharging ESS 104 to the maximum, fully charged capacity. That is, the performance recovery routine includes a deep depth discharge of ESS 104. However, the type of performance recovery routine may vary. For example, the type of ESS 104 used may dictate the type of performance recovery routine used, e.g., it may vary based on model type of ESS 104. In another example, the performance recovery routine could vary based on certain end discharge levels, certain discharge rates, or with certain temperature limitations. In other embodiments, the performance recovery routine may not include directly fully discharging ESS 104 (see point 270 in FIG. 9) from a partially discharged state and then recharging ESS 104 to the maximum, fully charged capacity, but could be performed in a repeating or pulsed manner, or in a manner particular to ESS 104. The discharge operation could be performed by loading ESS 104 (to discharge it) via electric aircraft 100 operation, or through vehicle-to-ground-based system such as charging system 103, e.g., store energy in charging system 103 or discharge it to ground. Those with skill in the art will recognized that various alternative approaches to the performance recovery routine are also possible.

In other embodiments, system 90 may implement a corrective action by modifying flight plan 238 of electric aircraft 100, which may also modify mission profile 240, 242. For example, system 90 may change a flight path of electric aircraft 100, reduce a duration of the flight, reduce a power demand of the flight, and/or convert a phase of a flight from a thrust-borne phase to a wing-borne phase (where possible). The changes may be automatically implemented or provided to a user for selection, e.g., via a graphical user interface of system 90.

In certain situations, performing a performance recovery routine on ESS 104 may be required, but may be temporarily not possible. This situation may occur for a variety of reasons such as but not limited to where electric aircraft 100 cannot be fully discharged due to location, reserve energy requirements, etc. Where performing the performance recovery routine on ESS 104 is temporarily not possible, system 90 may implement the corrective action in other ways. For example, system 90 may implement a corrective action by adjusting mission profile 240, 242 by at least one of the following actions until the performance recovery routine is performed: changing a flight path of electric aircraft 100, reducing a duration of the flight, reducing a power demand of the flight, and converting a phase of a flight from a thrust-borne phase to a wing-borne phase.

Embodiments of the disclosure may also implement system 90 as a flight planning system (or part thereof) for a flight of electric aircraft 100. In this case, in process P10, computing device 204 receives a usage history from ESS 104 of the electric aircraft including a number of cycles of partial discharging and recharging of ESS 104, i.e., as part of battery status information 236 or computational model 246. As described herein, in process P12, system 90 calculates a performance capability envelope of ESS 104 for electric aircraft 100 based on mission profile 240, 242 for the flight of electric aircraft 100 and a computational model 246 of ESS 104 that includes the usage history. Also, in process P12, system 90 calculates a reduced performance capability according to a memory effect degradation that accounts for the usage history of ESS 104. In processes P14 and P16, as described herein, system 90, in response to determining ESS 104 exceeds the performance capability envelope during the flight outside of a preset tolerance, implements a corrective action so ESS 104 does not exceed the performance capability envelope. As described herein, the corrective action may include performing a performance recovery routine to increase an energy storage capability of ESS 104. Also, as described herein, the performance recovery routine may include fully discharging ESS 104 from a partially discharged state and then recharging ESS 104 to a maximum, fully charged capacity. System 90 may also implement the corrective action by modifying flight plan 238 of electric aircraft 100, as described herein. For example, flight plan 238 may be modified by at least one of: changing a flight path of the electric aircraft, reducing a duration of the flight, reducing a power demand of the flight, and converting a phase of a flight from a thrust-borne phase to a wing-borne phase.

Embodiments of the disclosure provide various technical and commercial advantages, examples of which are discussed herein. Systems described herein implement a corrective action, e.g., a performance recovery routine, based on a performance deficiency indicated by the performance capability envelope that may considers a mission profile and a computational model of the ESS, including perhaps memory effect degradation. Hence, the performance recovery routine can be more accurately used to ensure the electric vehicle can complete the mission.

The flowchart and block diagrams in the drawings illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

As discussed herein, various systems and components are described as “generating” data (e.g., system 90, etc.). It is understood that the corresponding data can be obtained using any solution. For example, the corresponding system/component can generate and/or be used to generate the data, retrieve the data from one or more data stores (e.g., a database), receive the data from another system/component, and/or the like. When the data is not generated by the particular system/component, it is understood that another system/component can be implemented apart from the system/component shown, which generates the data and provides it to the system/component and/or stores the data for access by the system/component.

The foregoing drawings show some of the processing associated according to several embodiments of this disclosure. In this regard, each drawing or block within a flow diagram of the drawings represents a process associated with embodiments of the method described. It should also be noted that in some alternative implementations, the acts noted in the drawings or blocks may occur out of the order noted in the figure or, for example, may in fact be executed substantially concurrently or in the reverse order, depending upon the act involved. Also, one of ordinary skill in the art will recognize that additional blocks that describe the processing may be added.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application and to enable others of ordinary skill in the art to understand the disclosure for various embodiments with various modifications as are suited to the particular use contemplated.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise. “Approximately” or “about,” as applied to a particular value of a range, applies to both end values and, unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiments were chosen and described in order to best explain the principles of the disclosure and the practical application of the technology and to enable others of ordinary skill in the art to understand the disclosure for contemplating various modifications to the present embodiments, which may be suited to the particular use contemplated.

What is claimed is:

1. A system, comprising:
a computing device configured to:
calculate a performance capability envelope of an energy storage system for an electric aircraft based on a mission profile for a future usage period of the energy storage system and a computational model of the energy storage system, wherein the mission profile includes at least one of an expected energy demand and an expected power demand during at least a portion of a flight of the electric aircraft; and
implement a corrective action in response to a comparison of the mission profile to the calculated performance capability envelope indicating a performance deficiency where the energy storage system cannot meet the mission profile within a preset tolerance.

2. The system of claim 1, wherein the computational model includes a usage history of the energy storage system, and calculating the performance capability envelope includes reducing a performance capability according to a memory effect degradation that accounts for the usage history of the energy storage system.

3. The system of claim 2, wherein the corrective action includes performing a performance recovery routine to increase an energy storage capability of the energy storage system.

4. The system of claim 2, wherein the computational model of the energy storage system for the electric aircraft includes at least one of the following characteristics of the energy storage system:
an historical performance of the energy storage system,
a charging history of the energy storage system, and
empirical performance data based on a chemistry of the energy storage system.

5. The system of claim 1, wherein implementing the corrective action includes performing a performance recovery routine to increase an energy storage capability of the energy storage system to a maximum, fully charged capacity.

6. The system of claim 5, wherein the performance recovery routine includes fully discharging the energy storage system from a partially discharged state and then recharging the energy storage system to the maximum, fully charged capacity.

7. A method, comprising
calculating a performance capability envelope of an energy storage system for an electric aircraft based on a mission profile for a future usage period of the energy storage system and a computational model of the energy storage system, wherein the mission profile includes at least one of an expected energy demand and an expected power demand during at least a portion of a flight of the electric aircraft; and
implementing a corrective action in response to a comparison of the mission profile to the calculated performance capability envelope indicating a performance deficiency where the energy storage system cannot meet the mission profile within a preset tolerance.

8. The method of claim 7, wherein the computational model includes a usage history of the energy storage system, and calculating the performance capability envelope includes reducing a performance capability according to a memory effect degradation that accounts for the usage history of the energy storage system.

9. The method of claim 8, wherein the corrective action includes performing a performance recovery routine to increase an energy storage capability of the energy storage system.

10. The method of claim 8, wherein the computational model of the energy storage system for the electric aircraft includes at least one of the following characteristics of the energy storage system:
an historical performance of the energy storage system,
a charging history of the energy storage system, and
empirical performance data based on a chemistry of the energy storage system.

11. The method of claim 7, wherein implementing the corrective action includes performing a performance recovery routine to increase an energy storage capability of the energy storage system to a maximum, fully charged capacity.

12. The method of claim 11, wherein the performance recovery routine includes fully discharging the energy storage system from a partially discharged state and then recharging the energy storage system to the maximum, fully charged capacity.

13. The method of claim 11, wherein, where performing the performance recovery routine on the energy storage system is temporarily not possible, further including adjusting the mission profile by at least one of the following until the performance recovery routine is performed: changing a flight path of the electric aircraft, reducing a duration of the flight, reducing a power demand of the flight, and converting a phase of a flight from a thrust-borne phase to a wing-borne phase.

14. The method of claim 7, wherein implementing the corrective action includes modifying a flight plan of the electric aircraft.

15. The method of claim 7, wherein the performance deficiency includes the expected energy demand exceeding a respective energy capability of the energy storage system beyond the preset tolerance therefor.

16. The method of claim 7, wherein the performance deficiency includes the expected power demand exceeding a respective power capability of the energy storage system beyond the preset tolerance therefor.

17. The method of claim 7, wherein the mission profile further includes an expected energy reserve after completion of the flight, and the performance deficiency includes the expected energy reserve of the mission profile being below the preset tolerance therefor.

18. A flight planning system for a flight of an electric aircraft, comprising:
a computing device configured to:
receive a usage history from an energy storage system of the electric aircraft including a number of cycles of partial discharging and recharging of the energy storage system;
calculate a performance capability envelope of an energy storage system for the electric aircraft based on a mission profile for the flight of the energy storage system and a computational model of the energy storage system that includes the usage history, the calculating reducing a performance capability according to a memory effect degradation that accounts for the usage history of the energy storage system; and
in response to determining the energy storage system exceeds the performance capability envelope during the flight outside of a preset tolerance, performing a corrective action so the energy storage system does not exceed the performance capability envelope.

19. The flight planning system of claim 18, wherein the corrective action includes performing a performance recovery routine to increase an energy storage capability of the energy storage system.

20. The flight planning system of claim 18, wherein the corrective action includes modifying a flight plan of the electric aircraft.
